(19) United States
(12) Patent Application Publication
(10) Pub. No.: US 2002/0158730 A1
(43) Pub. Date: Oct. 31, 2002

(54) Reed switch

(76) Inventors: Hirofumi Okano, Saitama Prefecture (JP); Keiji Shimoyama, Saitama Prefecture (JP)

Correspondence Address: NIXON & VANDERHYE P.C., 8th Floor, 1100 North Glebe Rd., Arlington, VA, 22201-4714, US

(21) Appl. No.: 09/987,330

(22) Filed: Nov. 14, 2001

(30) Foreign Application Priority Data
Apr. 25, 2001 (JP) 2001-127224

(51) Int. Cl. H01H 1/66

(52) U.S. Cl. 335/151

(57) ABSTRACT

In the conventional fluid level detector, the reed switch is accommodated in the housing formed of an insulating material such as a resin or the like to prevent the reed switch from coming into direct contact with fluid and being electrically shorted. However, since such a construction requires the steps of storing and fixing the reed switch in the housing and leading out the lead therefrom, workability is low, the housing must be manufactured separately, and thus the cost increases. Accordingly, a reed switch wherein at least the tubular bulb portion is molded with a hot-melt resin is provided.

### BACKGROUND OF THE INVENTION

1. Field of the Invention

The present invention relates to an improved reed switch built in the fluid level detector or the like for detecting the level of the fluid stored in the tank or the like.

2. Description of the Related Art

A reed switch to be built in the conventional fluid level detector is disclosed, for example, in Japanese Patent Application Publication No. 7-110256. The reed switch disclosed in this publication comprises a hollow housing to be immersed in fluid, a cap for closing the opening of the housing, a reed switch inserted in the housing with the lead portion fixed to the cap, and a float having a magnet that is movable vertically around the outer periphery of the housing.

The action of the structure described above in the fluid level detector is such that the float moves vertically according to the amount of fluid, and the reed switch is turned on when the magnet in the float comes close to the reed switch, and when the reed switch is turned on, the alarm or the like is activated to signal that the fluid level reaches the predetermined position.

In the conventional fluid level detectors, the reed switch is stored in the housing formed of insulating material such as resin or the like to prevent the reed switch from coming into direct contact with fluid and being electrically shorted. However, since such a construction requires the steps of storing and fixing the reed switch in the housing and leading out the lead therefrom, workability is low, the housing must be manufactured separately, and thus the cost increases.

### SUMMARY OF THE INVENTION

Accordingly, it is an object of the present invention to solve the problem described above, and to provide a reed switch at low cost by molding the reed switch with a hot-melt resin that is lower in temperature and requires lower injection pressure, which contributes to mold the tubular bulb without damaging the same.

The reed switch of the present invention is intended to achieve the object described above, and the measure is to mold at least the tubular bulb with a hot-melt resin, or the tubular bulb and the lead let out from the tubular bulb are molded with a hot-melt resin.

Preferably, the tubular bulb, the lead portion led out from the tubular bulb, and the terminal connected to lead portion and to be connected to the connector from the control unit are molded with the hot-melt resin with a part of the terminal exposed, and the molded potion may be formed with a mounting device to be fixed to the mounted body such as a tank or the like on the outer periphery thereof.

### BRIEF DESCRIPTION OF THE DRAWINGS

FIG. 1 is a cross sectional view of a reed switch according to the present invention; and

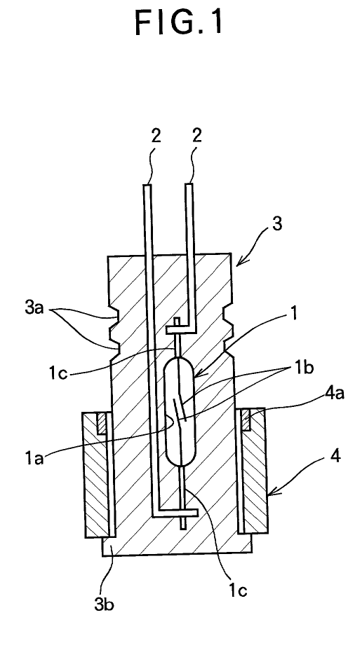

FIG. 2 is a temperature-pressure plot of the injection molding comparing a hot-melt resin and a generally used resin.

### DESCRIPTION OF THE PREFERRED EMBODIMENTS

An embodiment of the reed switch according to the present invention will be described taking the case of being employed in a fluid level detector as an example.

A known reed switch designated by the reference numeral 1 comprises a tubular bulb la formed of a glass tube, two leads 1b that are magnetized and turned ON when a magnet comes close thereto, and leads 1c electrically connected to the leads 1b.

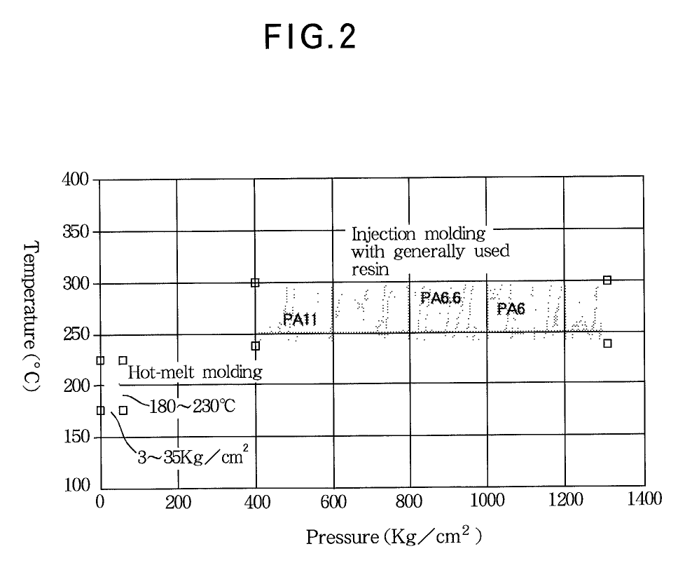

The reference numeral 2 designates a terminal connected to the lead c of the reed switch 1 by soldering or the like, and to be connected to the connector. The reference numeral 3 is a molded portion that is formed by molding the entire lead switch 1 with the upper ends of the terminals 2 exposed with a hot-melt resin that requires a temperature of 180 to 202° C. and an injection pressure of 3 to 35 Kg/cm² for injection molding as shown in FIG. 2.

The upper portion of the molded portion 3 is integrally formed with two mounting devices 3a in the shape of annular grooves or the like for resiliently mounting the molded portion on a mounted body (not shown) such as a tank or the like, and with a stopper 3b for preventing a float 4 that will be described later from slipping off at the time of molding.

The reference numeral 4 designates a ring-shaped float formed of a buoyant material having a diameter slightly larger than the outer dimension of the molded portion 3, thereby being capable of moving vertically with respect to the molded portion 3. A magnet 4a for turning the lead 1a of the reed switch 1 ON is integrally mounted on the float 4.

With the fluid level detector in such a construction, a part of the reed switch 1 and the terminal 2 are molded with a hot-melt resin that requires lower temperature and much lower pressure for injection molding in comparison with the generally used molding resin (injection molding temperature: 240 to 300° C., injection molding pressure 400 to 1300 Kg/cm², See FIG. 2), and thus the tubular bulb la of the reed switch 1 is prevented from being melted or being damaged.

Since the hot-melt resin is a material that is primarily used for adhesive agent, it exhibits superior adhesiveness, waterproof property, dust-proof property, and shake-proof property, and thus molding the reed switch 1 with the hot-melt resin having such characteristics helps to prevent fluid from entering therein and to increase in resistance to vibration caused by the vertical movement of the float 4, thereby preventing occurrence of breakdown.

As described above, molding the reed switch 1 with the hot-melt resin prevents electrical short-circuit caused by liquid from occurring when it is immersed into fluid. Therefore, ON and OFF operation of the read switch 1 can be preformed accurately and reliably by the vertical movement of the float 4, and thus the position of the fluid level can be reliably detected.

Since the reed switch 1 in the embodiment described above is employed in the fluid level detector, which is immersed into liquid, the case where the lead 1c and a part of the terminal 3 are integrally molded is shown as an example. However, when the reed switch 1 is used for the object other than fluid level detection, and either one of the reed switch 1 or the magnet moves vertically to detect the position of the reed switch 1 or the magnet, molding only the tube bulb portion 1a or molding the tubular bulb portion 1a and the lead 1c may be sufficient.

As described above, since at least the tubular bulb portion is molded with the hot-melt resin that requires lower temperature and pressure for injection molding, the tubular bulb is prevented from being melted by the temperature of the resin or from being damaged by the pressure exposed at the time of the injection molding.

Since the tubular bulb portion and the lead led out from the tubular bulb portion are also molded with the hot-melt resin, or the tubular bulb portion, the lead led from the tubular bulb portion, and the terminal connected to the lead and to be connected to the connector from the control unit are molded with the hot-melt resin with a part of the terminal exposed, it has an advantage in that the reed switch can be used under any condition owing to adhesiveness, waterproof property, dust-proof property, and shake-proof property of the hot-melt resin.

What is claimed is:

1. A reed switch wherein at least the tubular bulb portion is molded with a hot-melt resin.

2. A reed switch wherein the tubular bulb portion and the lead led out from the tubular bulb portion are molded with the hot-melt resin.

3. A reed switch wherein the tubular bulb portion, the lead led out from the tubular bulb portion, and a terminal connected to lead and to be connected to the connector from a control unit are molded with the hot-melt resin with a part of the terminal exposed.

4. A reed switch as set forth in any one of claim 1 to claim 3, further comprising a mounting device formed on the outer periphery of the molded portion for fixing the reed switch on a mounted body such as a tank or the like.
